(19) United States
(12) Patent Application Publication
(10) Pub. No.: US 2003/0217595 A1
(43) Pub. Date: Nov. 27, 2003

(54) Remote tire pressure monitoring system with plastic thin-walled valve cap and method of installing the monitoring system

(76) Inventors: Frank S. Banzhof, Indian Trail, NC (US); Stephane D. Demontoux, Pontarlier (FR)

Correspondence Address: BRINKS HOFER GILSON & LIONE, P.O. BOX 10395, CHICAGO, IL, 60610, US

(21) Appl. No.: 10/395,036

(22) Filed: Mar. 21, 2003

Related U.S. Application Data
(60) Provisional application No. 60/366,671, filed on Mar. 21, 2002.

(51) Int. Cl. B60C 23/02

(52) U.S. Cl. 73/146.8; 340/442

(57) ABSTRACT

A remote tire pressure monitoring system and method for installing the system are disclosed. The remote tire pressure monitoring system includes a pressure monitor, a tire valve assembly including a valve stem, a retention nut, and a plastic thin-walled valve cap which fits on an open end of the valve assembly. The outer diameter of the thin-walled valve cap is smaller than the inner diameter of the retention nut. As a result, the retention nut fits over the thin-walled valve cap. The tire pressure monitoring system is installed on a tire rim by threading the tire valve assembly with the valve cap in place through an opening in the tire rim and then passing the retention nut over the valve cap and tightening the retention nut onto the valve stem.

This application claims the benefit of U.S. Provisional Patent Application Serial No. 60/336,671 filed on Mar. 21, 2002.

### BACKGROUND OF THE INVENTION

This invention relates to remote tire pressure monitoring systems, and in particular, tire pressure monitoring systems with improved plastic valve caps. The invention further relates to a method of installing such remote tire pressure monitoring systems.

Over last few years, snap-in tire valves have become very popular in the motor vehicle industry due to their ease of installation. However, clamp-in tire valves still are used in many applications, including on large motor vehicles and in high speed applications such as performance cars. Typically, clamp-in valve assemblies comprise a valve stem, a retention nut, and a valve cap.

Remote tire pressure monitoring systems can either use snap-in or clamp-in type valve stems. However, current remote tire pressure monitoring systems for larger vehicles such as trucks and buses are often very heavy. As a result, snap-in valves cannot be used with these systems because the weight of the monitoring system simply cuts the valve.

Clamp-in remote tire pressure monitoring systems are similar to clamp-in valves, but also include a tire pressure monitor affixed to one end of the valve stem. In order to install a prior art clamp-in tire pressure monitoring system on a tire rim, the tire valve stem is placed through an opening in the tire rim and then secured to the rim by passing the retention nut over the valve end opposite the pressure monitor and tightening the retention nut on the valve stem. The valve cap then is screwed onto the valve stem to form an airtight seal and prevent dust and dirt from entering the valve. Subsequently, a tire is mated to the rim, and a cowl is used to inflate the tire to a proper pressure. The wheel assembly is automatically balanced and finally installed on a vehicle. In short, the valve is not used to inflate the tire during this automated assembly process.

These clamp-in remote tire pressure monitoring systems have several disadvantages. First, the tire pressure monitoring system must be shipped to the vehicle or wheel assembly manufacturer in three separate pieces, the valve stem with affixed pressure monitor, the retention nut, and the valve cap. Thus, the valve manufacturer must assign three separate part numbers to the valve assembly, and the vehicle or wheel assembly manufacturer must keep track of three separate parts, two of which, the retention nut and valve cap, are relatively small. If the retention nut and valve cap are screwed onto the valve system prior to shipment, the vehicle manufacturer must remove the valve cap and the retention nut prior to installing the pressure monitoring system on the tire rim which adds two extra steps to the manufacturing process and additional labor costs.

While existing clamp-in remote tire pressure monitoring systems may be suitable for their intended purpose, it is believed that there is demand in the industry for an improved clamp-in remote tire pressure monitoring system which can be more quickly and easily installed onto a tire rim, but which is still cost effective.

### BRIEF SUMMARY OF THE INVENTION

The present invention is directed to an improved clamp-in remote tire pressure monitoring system and a method for installing the system on a tire rim. One aspect of the invention includes a tire pressure monitor and a valve assembly. The valve assembly further includes a valve stem, a fastener, and a thin-walled plastic valve cap. The tire pressure monitor is coupled to one end of the valve stem while the valve cap is coupled to the other end of the valve stem. The fastener has an inner diameter which is larger than the outer diameter of the valve cap so that the fastener fits over the valve cap when coupled to the valve stem.

Another aspect of this invention regards installing the tire pressure monitoring system on a tire rim. To that end, a tire pressure monitor and valve assembly, including a valve stem, fastener, and a thin-walled plastic valve cap are provided. The tire pressure monitor is coupled to one end of the valve stem, and the valve cap is coupled to the opposite end of the valve stem. Next, the valve stem is inserted valve cap first through an opening in the tire rim. The fastener is then fitted over the valve cap and coupled to the valve stem thereby affixing the tire pressure monitoring system to the tire rim.

The foregoing summary of the invention has been provided only as an introduction. Nothing in this section should be taken as a limitation on the following claims, which define the scope of the invention.

### BRIEF DESCRIPTION OF SEVERAL VIEWS OF THE DRAWINGS

FIG. 1 is a partial cross-sectional view of a tire pressure monitoring system utilizing a plastic thin-walled cap of the present invention;

FIG. 2 is a partial cross-sectional and exploded view of a tire valve assembly, including two embodiments of a valve cap used in the tire pressure monitoring system of FIG. 1;

FIG. 3 is a top view of one embodiment of the tire valve cap of the present invention;

FIG. 4 is a cross-sectional view of the tire valve cap of FIG. 3 taken along line 4-4;

FIG. 5 is an elevational view of the tire valve cap of FIG. 4;

FIG. 6 is a top view of a second embodiment of the tire valve cap of the present invention;

FIG. 7 is a cross-sectional view of the tire valve cap of FIG. 6 taken along line 7-7;

FIG. 8 is an elevational view of the tire valve cap of FIG. 7;

FIG. 9 is a perspective view of a third embodiment of the tire valve cap of the present invention;

FIG. 10 is a top view of the tire valve cap shown in FIG. 9;

FIG. 11 is a partial cross-sectional view of the tire valve cap of FIG. 8 taken along line 11-11; and

FIG. 12 is an enlarged cross sectional view of the valve cap and retention nut of the present invention.

### DETAILED DESCRIPTION OF THE INVENTION

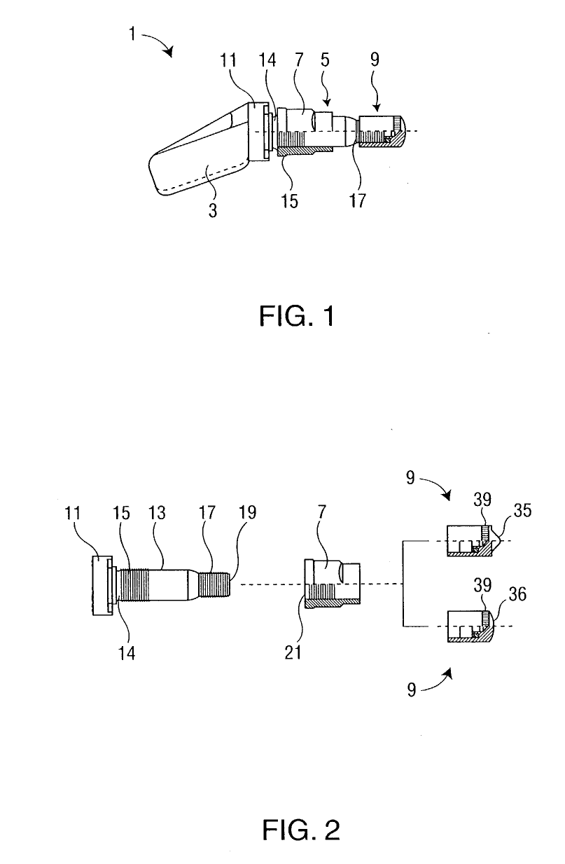

Turning now to the drawings, FIGS. 1 and 2 illustrate one embodiment of a tire pressure monitoring system 1 of the present invention. The monitoring system 1 includes a tire pressure monitor 3 and a tire valve assembly 5. The tire pressure monitor 3 may include electronic circuitry (not shown) which transmits information related to tire pressure and tire conditions to a remote receiver, which in turn transmits the information to the driver of the vehicle. Tire monitoring systems including such electronic circuitry are disclosed and described in U.S. Pat. Nos. 6,043,738, 6,005,480, and 5,963,128, the entire contents of which are hereby incorporated by reference.

The tire valve assembly 5 is a clamp-in type tire valve having a standard design. As shown in FIGS. 1 and 2, the valve assembly 5, includes a valve stem 13, a fastener or retention nut 7, and a valve cap 9. The stem 13 is generally cylindrical in shape and has exterior retention threads 15 at one end and exterior cap threads 17 adjacent an open valve end 19. A base 11 is positioned adjacent the retention threads 15 and is adapted to receive the tire pressure monitor 3. The retention nut 7 is used to secure the remaining pieces of the valve assembly 5 to a-tire rim. In particular, the inner diameter of the retention nut 7 is larger than the outer diameter of the valve stem 13 such that the retention nut fits over the valve stem. The retention nut 7 further has interior threads 21 which correspond to the exterior retention threads 15 on the valve stem 13 so that the retention nut 7 can be coupled to the valve stem 13 adjacent the base 11 via a threaded connection. The retention nut 7 is generally metal but may be any suitable material which can withstand the force exerted on the valve assembly during installation and use.

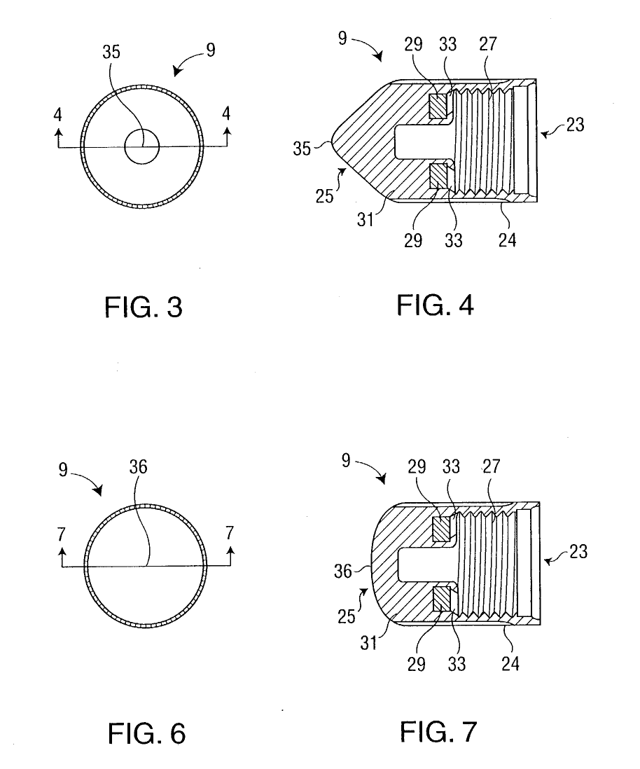

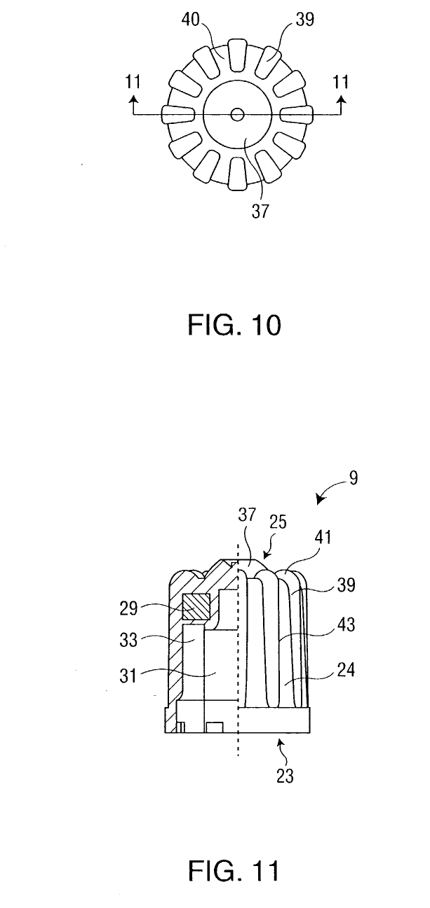

Referring now to FIGS. 3-12, in general, the valve cap 9 has an open end 23, a closed end 25, and side walls 24. The open end 23 of the valve cap 9 includes interior threads 27 which correspond to the cap threads 17 on the valve stem 13. As shown in detail in FIGS. 4, 7, and 11, the valve cap 9 includes a cut washer 29 positioned within an inner cavity 31 of the valve cap. The washer 29 is secured within the valve cap 9 by a retention member 33. The washer 29 may be rubber, nylon, or another suitable sealing material. A heat staking process is used to heat and spread the retention member 33 so that it can be rolled over the washer 29 to fix the washer in place. As those skilled in the art will appreciate, the washer 29 may be secured in place by other methods, including, but not limited to, adhesive and ultrasonic welding.

The diameter of the open end 23 of the valve cap 9 is slightly larger than the diameter of the stem end 19 so that the valve cap fits onto the open end 19. The valve cap 9 is secured by engaging threads 17 on the valve stem 13 and cap threads 27 and twisting the valve cap 9 onto the valve stem 13. In one embodiment, the washer 29 forms a generally airtight seal between the valve cap 9 and the valve stem 13.

Alternatively, the valve cap does not include a washer, so no airtight seal is formed between the valve cap 9 and the open valve end 19. In this situation, the cap serves to prevent dust and dirt from entering the valve assembly 5.

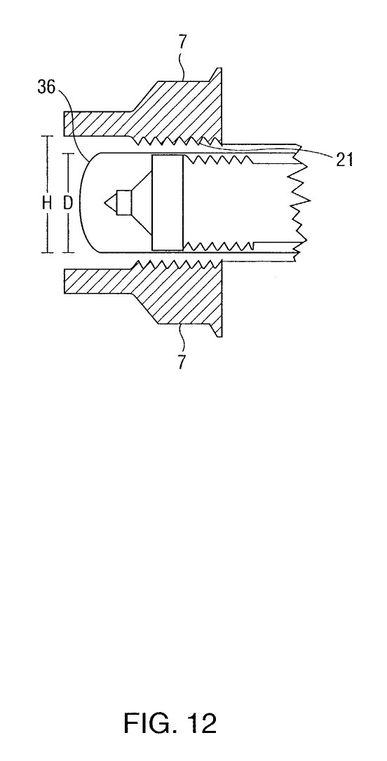

As shown in FIG. 12, the outer diameter D of the valve cap 9 is smaller than the inner diameter I of the retention nut 7 so that that the retention nut 7 fits over the valve cap 9 when installing the tire pressure monitoring system 1 on a tire rim. The smaller diameter of the valve cap 9 is obtained by constructing the side walls 24 of the cap 9 as thin as possible while still maintaining acceptable tolerances for the walls 24. In one embodiment, the side walls are about 0.028 inches thick at the interior threads 27 of the valve cap 9 and about 0.021 inches thick at the washer. The valve cap is generally constructed from plastic and is rigid in nature. In a preferred embodiment, the valve cover 9 is constructed from 6-6 nylon which is commercially available from The Dow Chemical Company.

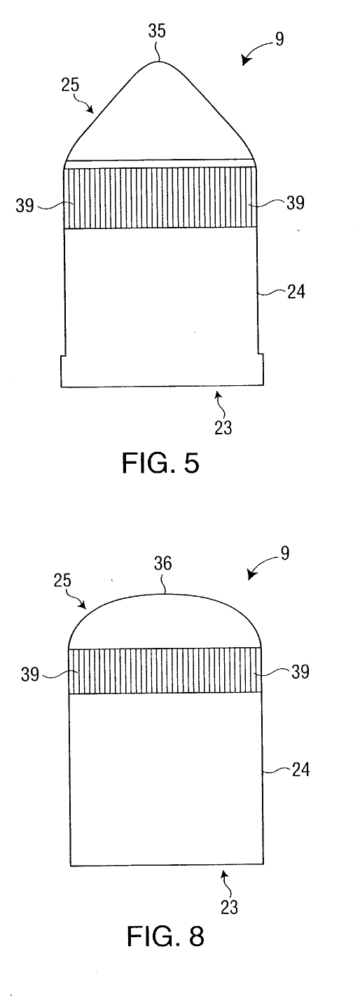

As shown in FIGS. 3-10, at least four embodiments for the valve cap 9 are contemplated. The first embodiment of the valve cap 9 shown in FIGS. 3-5 is bullet-shaped such that the closed end 25 of the cap terminates in a point 35. When secured to the valve stem 13, the bullet-shaped valve cap 9 allows the valve assembly 5 to be easily threaded through various apertures during the installation of the tire pressure monitoring system 1 on a tire rim. As shown in more detail in FIG. 5, a plurality of ribs 39 having generally jagged or sharp edges may surround a circumference of the valve cap 9. The ribs 39 increase the tactile friction of the valve cap 9 so that it is easier to hold on to cap when screwing and unscrewing the cap.

The second embodiment of the valve cap 9 shown in FIGS. 6-8 has a closed end 25 that terminates in a dome 36. Again, the dome shape allows for easier installation of the tire pressure monitoring system on a tire rim. As further shown in FIG. 8, ribs 39, similar to those depicted in FIG. 5, may surround the entire circumference of the valve cap 9.

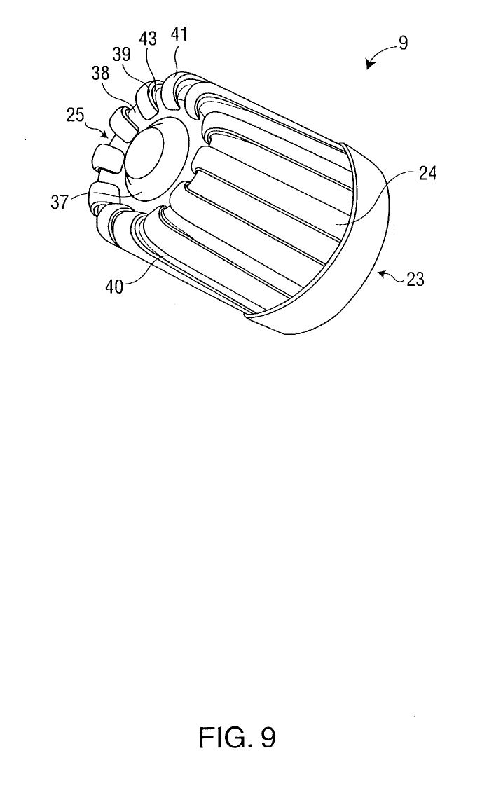

The third and fourth embodiments of the valve cap 9 are shown in FIGS. 9-11. In general, the valve cap 9 has a closed end 25 with a dome-shaped center 37 having a recess 38 centered in the dome 37. The dome-shaped center is surrounded by ribs 39. The ribs 39 extend from a point adjacent the dome-shaped center 37 on the top 40 of the valve cap down the side walls 24 and terminate at a point adjacent the open end 23 of the valve cap. In general, the ribs 39 have rounded upper surfaces 41 and rounded edges 43.

In order to install the tire pressure monitoring system 1 of the present invention, a tire rim (not shown), a pressure monitor 3, a tire valve assembly 5 having a valve stem 13, a retention nut 7, and a valve cap 9 are provided. The pressure monitor 3 is coupled to one end of the valve stem, and the valve cap 9 is coupled to the valve stem 13 opposite the pressure monitor 3. The valve stem 13 is inserted valve cap first through an opening in the tire rim until the tire pressure monitor contacts the tire rim. The retention nut 9 is passed over the valve cap 9 and screwed into place on the valve stem 13. When the retention nut 7 is tightened, the tire rim is retained securely in notch 14 (FIGS. 1 and 2) between the pressure monitor 3 and the retention nut 7. The tire rim and tire pressure monitoring system are then mated with a tire which is inflated with a cowl to a proper pressure. The wheel is then balanced and installed on a vehicle.

The use of the thin-walled plastic valve cap provides several advantages. First, because the retention nut fits over the valve cap, installation of the tire pressure monitoring system on a tire rim is a two step process (inserting the valve stem through the valve opening in the tire rim and tightening the retention nut onto the valve stem), instead of a three step process (threading the valve stem through the tire rim, tightening the retention nut, and screwing on the valve cap). Second, this streamlined installation process leads to reduced installation time which in turn increases production while lowering labor costs. Third, the use of the thin-walled valve caps allows tire pressure monitoring systems to be shipped to vehicle or wheel assembly manufacturers in two pieces, the valve stem with attached pressure monitor and valve cap and the retention nut, instead of three pieces. As a result, only two part numbers are necessary and vehicle or wheel assembly manufacturers only have to keep track of two separate pieces.

While the above description constitutes the preferred embodiments of the present invention, it will be appreciated that the invention is susceptible of modification, variation, and charge without departing from the proper scope and fair meaning of the accompanying claims.

1. A clamp-in tire valve comprising:
a valve stem having first and second ends,
a tire pressure monitor affixed to said first valve stem end;
a thin-walled plastic valve cap having an outer cap diameter, said valve cap removably coupled to said second valve stem end; and
a fastener having an inner fastener diameter, said fastener coupled to said valve stem adjacent said tire pressure monitor,
wherein the outer cap diameter is smaller than the inner fastener diameter.

2. The clamp-in tire valve of claim 1, wherein the valve cap further comprises an inner cavity and a washer positioned in said cavity.

3. The clamp-in tire valve of claim 2, wherein the washer comprises rubber or nylon.

4. The clamp-in tire valve of claim 2, wherein an airtight seal is formed between said second valve stem end and said valve cap when said valve cap is coupled to said valve stem.

5. The clamp-in valve of claim 1, wherein the valve cap is coupled to said second valve stem end by a threaded connection.

6. The clamp-in valve of claim 1, wherein the fastener is coupled to the valve stem by a threaded connection.

7. The clamp-in tire valve of claim 1, wherein the valve cap is bullet-shaped.

8. The clamp-in tire valve of claim 1, wherein the valve cap further comprises a domed-shaped closed end.

9. The clamp-in tire valve of claim 1, wherein said valve cap further comprises side walls, a closed end, a dome having recess centered on said closed end, and a plurality of ribs extending adjacent said dome and down said side walls.

10. The clamp-in tire valve of claim 1, wherein the valve cap further has a circumference and a plurality of ribs extending around said circumference.

11. The clamp-in tire valve of claim 9, wherein the ribs have sharp edges.

12. The clamp-in tire valve of claim 9, wherein the ribs have rounded edges.

13. The clamp-in tire valve of claim 10, wherein the ribs have sharp edges.

14. The clamp-in tire valve of claim 10, wherein the ribs have rounded edges.

15. The clamp-in valve of claim 1 wherein said valve cap comprises nylon 6-6.

16. The clamp-in tire valve of claim 1, wherein the pressure monitor comprises electronic circuitry for sensing the conditions of a tire.

17. A method of installing a tire pressure monitoring system comprising:
providing a pressure monitor;
coupling said pressure monitor to a first end of a valve stem,
coupling a plastic thin-walled plastic valve cap to a second end of said valve stem opposite said first end;
providing a tire rim with at least one opening for receiving said valve stem;
threading said valve stem valve cap first through said opening in said tire rim;
passing a fastener over said valve cap; and
coupling said fastener to said valve stem.

18. The method of claim 17 wherein said valve cap and said fastener are removably coupled to said valve stem by a threaded connection.

19. The method of claim 17 wherein the valve cap further comprises an inner cavity and a washer positioned in said cavity.

20. The method of claim 17 further comprising:
mating said tire rim to a tire;
inflating said tire through a cowl to a specified pressure; and
installing said tire on a motor vehicle.
